(19) United States
(12) Patent Application Publication
(10) Pub. No.: US 2008/0227080 A1
(43) Pub. Date: Sep. 18, 2008

(54) STUDENT ASSESSMENT SYSTEM

(75) Inventors: Donald Paul Keeler, Liberty, MO (US); Jon Pierce Hefling, Kansas city, MO (US)

Correspondence Address: LATHROP & GAGE LC, 2345 GRAND AVENUE, SUITE 2800, KANSAS CITY, MO, 64108, US

(73) Assignee: GeKL Technologies, Inc.

(21) Appl. No.: 11/686,215

(22) Filed: Mar. 14, 2007

(51) Int. Cl. G09B 7/00

(52) U.S. Cl. 434/350

(57) ABSTRACT

Input and storage devices, student assessment systems, and methods of administering an examination are disclosed herein. An input and storage device according to one embodiment includes at least one processor, provisions for inputting answer data to the processor, and computer memory coupled to the processor. Recorded within the computer memory are machine readable instructions for: storing the answer data previously input to the processor; providing the stored answer data to a reader device; storing unique identifier data that corresponds to a user; and providing the stored unique identifier data to a reader device. The instructions for providing the stored unique identifier data to a reader device may be utilized independently of the instructions for providing the stored answer data to a reader device.

### BACKGROUND

Schools conduct numerous examinations to determine students' progress, to assess whether skills have been learned, and for other reasons. These examinations are often given in multiple choice form, and students often mark their answers on pre-printed test sheets (sometimes referred to as “bubble sheets” or “optical scan sheets”) that can later be read by a machine. The pre-printed test sheets are only single-use, and as such, many pre-printed test sheets must be purchased. This is expensive, requires the destruction of excessive natural resources (e.g., trees used to manufacture paper), and creates excessive waste once the test sheets are used.

### SUMMARY

An input and storage device according to an embodiment includes at least one processor, provisions for inputting answer data to the processor, and computer memory coupled to the processor. Recorded within the computer memory are machine readable instructions for: storing the answer data previously input to the processor; providing the stored answer data to a reader device; storing unique identifier data that corresponds to a user; and providing the stored unique identifier data to a reader device. The instructions for providing the stored unique identifier data to a reader device may be utilized independently of the instructions for providing the stored answer data to a reader device.

A student assessment system according to an embodiment includes a student device and a reader device. The student device has at least one processor, a keypad in data communication with the student device processor for inputting answer data to the student device processor, provisions for powering the student device processor, computer memory in data communication with the student device processor, and a display in data communication with the student device processor. Recorded within the student device computer memory are machine readable instructions for: storing answer data input to the student device processor via the keypad; and storing unique identifier data that corresponds to a user. The reader device has at least one processor, an input device in data communication with the reader device processor, provisions for powering the reader device processor, computer memory in data communication with the reader device processor, and a display in data communication with the reader device processor. Also included are provisions for transferring the stored answer data to the reader device processor and provisions for transferring the stored unique identifier data to the reader device processor.

A method of administering an examination according to an embodiment includes the steps of: A) providing each of a plurality of students with a respective student device, each student device having at least one processor, a keypad in data communication with the student device processor for inputting answer data to the student device processor, means for powering the student device processor, computer memory in data communication with the student device processor, and a display in data communication with the student device processor; B) providing at least one examination question without use of the student devices; C) having the students utilize the respective keypads to input answer data to the respective student device processors; D) providing a reader device having at least one processor, an input device in data communication with the reader device processor, means for powering the reader device processor, computer memory in data communication with the reader device processor, and a display in data communication with the reader device processor; and E) transferring answer data from the respective student device computer memories to the reader device processor. The student device computer memory has recorded within it machine readable instructions for storing answer data input to the student device processor via the keypad and storing unique identifier data that corresponds to a user.

### BRIEF DESCRIPTION OF THE DRAWINGS

FIG. 1 shows a student assessment system according to an embodiment.

FIG. 2 schematically shows elements of the student assessment system of FIG. 1.

FIG. 3 schematically shows communication hardware according to an embodiment.

FIG. 4 shows the student assessment system of FIG. 1, but with a reader device according to another embodiment.

FIG. 5 shows an exemplary method of administering an examination.

### DETAILED DESCRIPTION

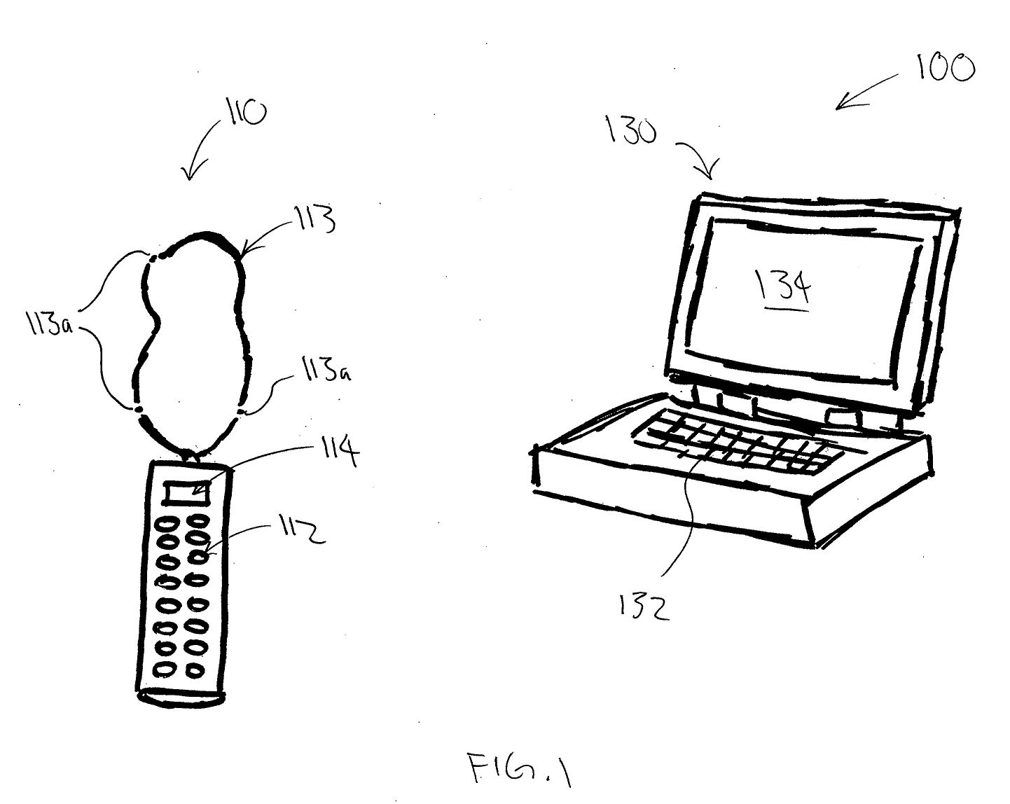

FIG. 1 shows a student assessment system 100 according to one embodiment. The student assessment system 100 includes at least one student device 110 (also referred to herein as an “input and storage device”) and at least one reader device 130. “Student” is used herein to refer to anyone who answers examination questions, and “examination” is used herein to broadly refer to a set of questions being answered by the student. “Examination” as used herein may refer to a test, a survey, etc.

Each student device 110 includes a keypad 112 and a display 114. The keypad may be an alphanumeric keypad (the keypad 112 may include numbers, letters, mathematical symbols, arrows, etc.,) or the keypad 112 may include other appropriate indicia such as animal representations, words (i.e., “yes”, “no”,) etc. While the keypad 112 shown in FIG. 1 has an elongate “bookmark” configuration, other configurations may also be used. Another embodiment currently includes an approximately two and one-half inch by two and one-half inch square configuration, for example. The display 114 may be a liquid crystal display or may be any other appropriate display. Considerations in choosing a display technology may include visibility, durability, power requirements, and cost, among others. Each student device 110 may include a lanyard 113 for placement about a user's neck. The lanyard 113 may be a break-away lanyard to minimize choking risks. For example, break away sections 113a may be included that may sever upon receiving a predetermined amount of force.

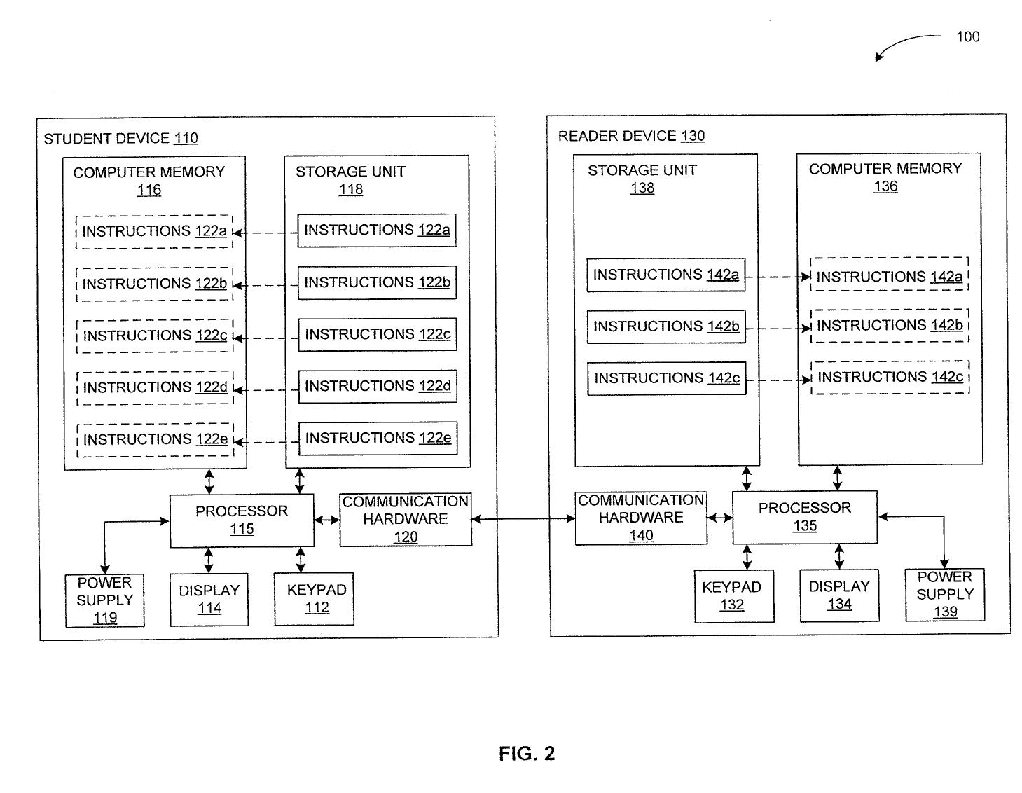

Referring now to FIG. 2, each student device 110 may further include at least one processor 15, computer memory 116, a storage unit 118, and communication hardware 120. The storage unit 118 may be, for example, a disk drive that stores programs and data of the student device 110. It should be appreciated that the student device 110 may be constructed without the storage unit 118, though the storage unit 118 may provide additional programming flexibility. The processor 115 is in data communication with the keypad 112, the display 114, the computer memory 116, and the communication hardware 120. A power supply 119 (i.e., AC power or DC power, including a battery or a solar cell, for example) is electrically coupled to the processor 115 to power the processor 115.

The storage unit 118 is illustratively shown storing (and providing to computer memory 116) machine readable instructions 122a for storing answer data input to the processor 115 via the keypad 112, machine readable instructions 122b for storing unique identifier data that corresponds to a user, machine readable instructions 122c for providing the stored answer data, machine readable instructions 122d for providing the stored unique identifier data, and machine readable instructions 122e for actuating the display 114 to present the stored answer data. As noted above, however, the instructions may be contained in the computer memory 116 without use of the storage unit 118. The communication hardware 120 may be a magnetic coil, a frequency transmitter and receiver, or any other appropriate transmitter and receiver currently known or developed in the future. The processor 115, the keypad 112, the display 114, the computer memory 116, and the communication hardware 120 may be operatively coupled to the lanyard 113 (FIG. 1), such as by sharing a housing that is coupled to the lanyard 113, for example.

Returning to FIG. 1, the reader device 130 includes an input device 132 and a display 134. The input device 132 may include a keypad (including a keyboard,) a mouse, trackball, joystick, or any other device that may be used to input electronic data. The display 134 may be a computer monitor (including a laptop monitor), a projection device, a LCD display, a cathode ray tube display, a plasma display, a LED display, or any other visual imaging device.

Referring now to FIG. 2, the reader device 130 may further include at least one processor 135, computer memory 136, a storage unit 138, and communication hardware 140. The storage unit 138 may be, for example, a disk drive that stores programs and data of the reader device 130. It should be appreciated that the reader device 130 may be constructed without the storage unit 138, though the storage unit 138 may provide additional programming flexibility. The processor 135 is in data communication with the input device 132, the display 134, the computer memory 136, and the communication hardware 140. A power supply 139 (i.e., AC power or DC power) is electrically coupled to the processor 135 to power the processor 135.

The storage unit 138 is illustratively shown storing (and providing to computer memory 136) machine readable instructions 142a for requesting and receiving the stored input data, machine readable instructions 142b for requesting and receiving the stored unique identifier data, and machine readable instructions 142c for associating the respective unique identifier data with identities of respective students. As noted above, however, the instructions may be contained in the computer memory 136 without use of the storage unit 138. The communication hardware 140 may be a magnetic coil, a frequency transmitter and receiver, an optical transmitter and receiver, or any other appropriate transmitter and receiver currently known or developed in the future. The communication hardware 120 and the communication hardware 140 must be able to communicate with one another, however.

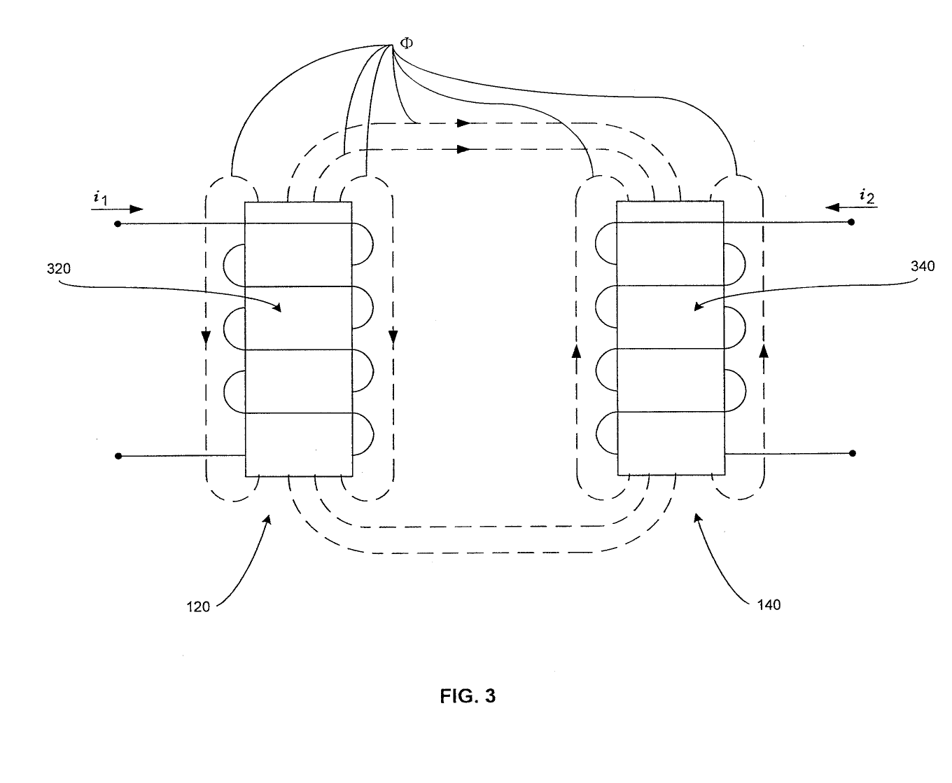

FIG. 3 shows a schematic representation of the communication hardware 120, 140 according to one embodiment. In this embodiment, the communication hardware 120 includes a magnetic coil 320, and the communication hardware 140 includes a magnetic coil 340. Electrical current from the power supply 119 is represented by arrow i1, and electrical current from the power supply 119 is represented by arrow i2. Flux lines Φ are created due to the magnetic coils 320, 340, and the flux lines Φ passing between the magnetic coils 320, 340 create a magnetically coupled circuit through which data may be electrically transferred. The range of communication may be altered by changing the amount of current passing through the coils 320, 340 and by modifying the coils 320, 340, for example. A communication range of less than six inches for the magnetically coupled circuit may be desirable to avoid unwanted data transfer or interference and to limit the required electrical current, though other communication ranges may also be utilized.

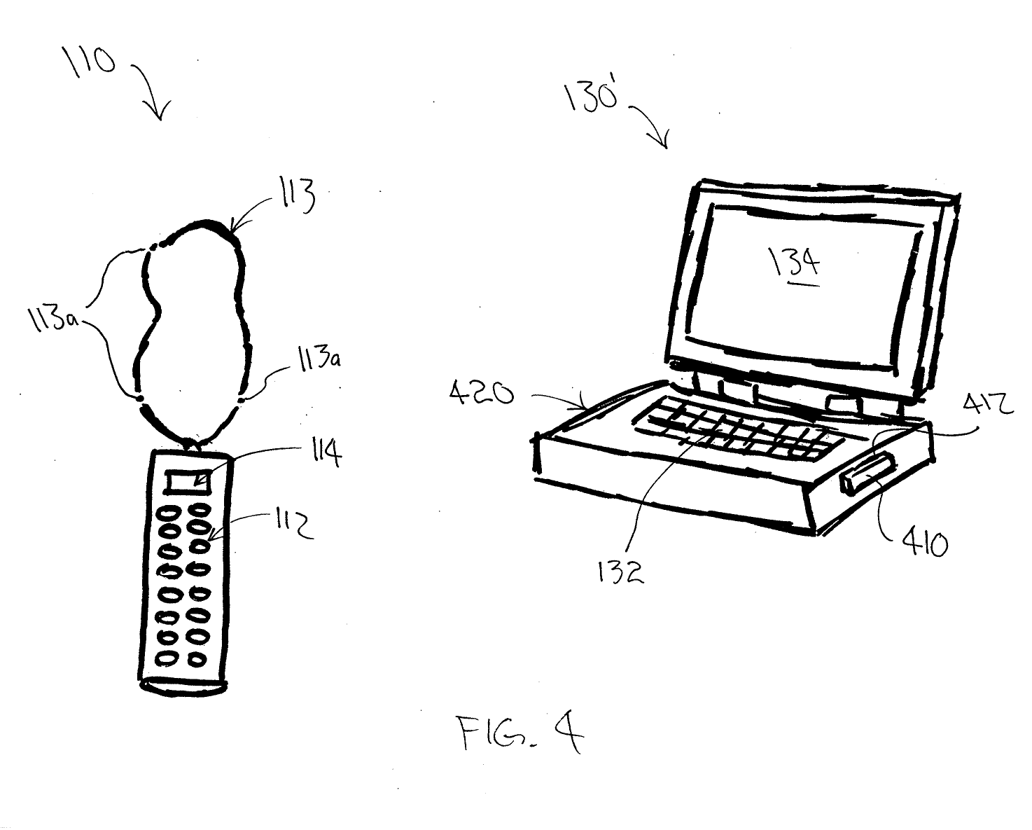

FIG. 4 shows the student assessment system 100 generally as discussed above, but with the reader device 130 according to another embodiment. The reader device is denoted 130′ in FIG. 4. The reader device 130 shown in FIG. 1 is a unified device, while the reader device 130′ shown in FIG. 4 includes a distinct reader unit 410 and a personal computer 420. The reader unit 410 is removably coupled to the personal computer 420, such as through a data port 412 (e.g., a Universal Serial Bus “USB” port, a serial port, etc.). The personal computer 420 includes the input device 132, the display 134, the processor 135, and the computer memory 136. The reader unit 410 includes the communication hardware 140 (e.g., the magnetic coil 340 shown in FIG. 3, etc.). The utilization of the distinct personal computer 420 as shown in FIG. 4 may minimize the cost of the reader device 130′ when compared to the reader device 130 as shown in FIG. 1, as only the reader unit 410 and the instructions for the computer memory 136 (as set forth above) may have to be purchased if the user already has the personal computer 420.

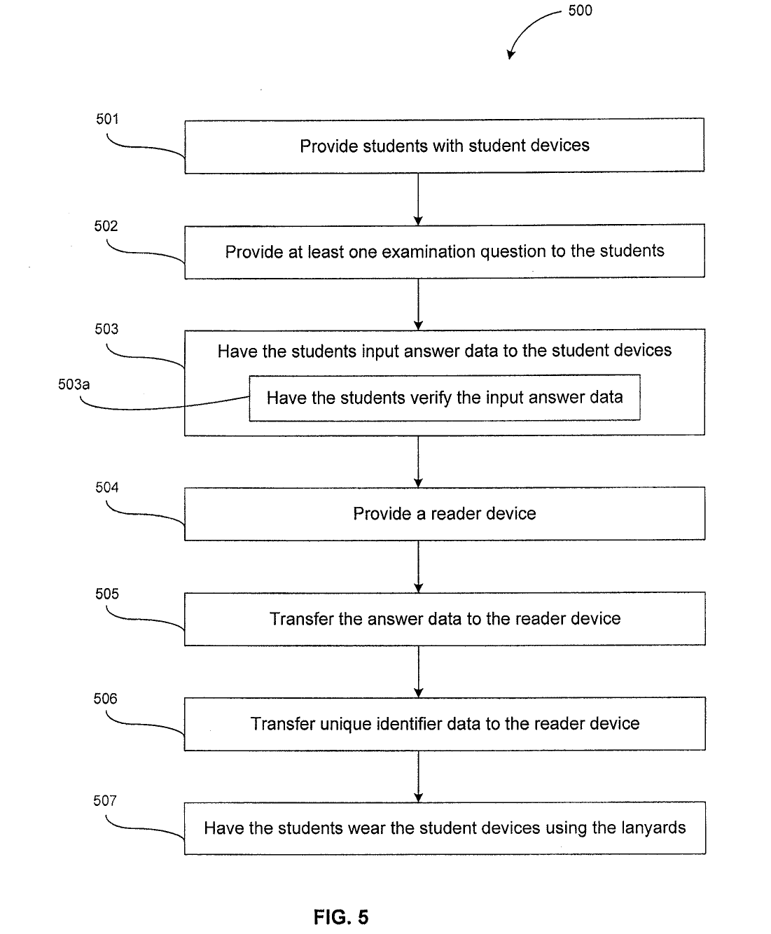

FIG. 5 shows an exemplary method 500 of administering an examination. At step 501, students are provided with respective student devices 110. The students may be provided with the student devices 110 at orientation, enrolment, the first day of classes, or at another appropriate time. Each processor 115 may use the instructions 122b for storing unique identifier data to store unique identifier data, which allows each student device 110 to correspond to a respective student.

At step 502, at least one examination question is provided to the students. The question is provided without use of the student devices 110, meaning that the student devices 110 do not provide the question. The question may be provided, for example, on paper, on a projector screen, orally, or in another appropriate manner.

At step 503, the students utilize the respective keypads 112 to input answer data to the respective student device processors 115. It should be appreciated that each processor 115 may use the instructions 122a for storing answer data to store the answer data. Step 503 may include step 503a, where the students utilize the respective student device displays 114 to verify the input answer data, or in other words, to make sure the input was intended. Each processor 115 may use the instructions 122e to actuate the displays 114. The student may change the answer data if desired.

At step 504, the reader device 130 is provided. It should be appreciated that many steps in the method 500 may be performed in various orders; step 504 may be performed before or after step 501, for example.

At step 505, the answer data in the respective student device computer memories 116 is transferred to the reader device processor 135. To perform the transfer, the reader device processor 135 may utilize the communication hardware 140 and the instructions 142a, and the student device processors 115 may utilize the communication hardware 120 and the instructions 122c.

At step 506, the respective unique identifier data may be transferred from the memories 116 to the reader device processor 135; in doing so, the instructions 122d, 142b and the communication hardware 120, 140 may be utilized. The transfer of the unique identifier data may be used to associate the answer data with the unique identifier data (and therefore the students) or to obtain the identity of the student in possession of the respective student device. It should be appreciated that the unique identifier data may be transferred independently of the answer data, and as such, the student devices 110 may serve as identification badges regardless of whether an examination is currently being conducted.

At step 507, students may be instructed to place the respective student devices 110 adjacent their necks using the respective lanyards 113. This placement may safeguard the student devices 110 and allow the student devices to easily function as identification badges.

As noted in relation to step 504, many of the steps in the method 500 can be performed in various orders. There are, however, basic limitations regarding the order of the steps. For example, step 505 may not be completed before step 503. It is anticipated that the students will maintain their respective student devices 110 in their possession for future use, and that various steps (e.g., steps 502, 503, 505, 506, 507) may be repeated for subsequent examinations.

Those skilled in the art appreciate that variations from the specified embodiments disclosed above are contemplated herein and that the described embodiments are not limiting. The description should not be restricted to the above embodiments, but should be measured by the following claims.

1. An input and storage device for use in completing an examination, the device comprising:
at least one processor;
means for inputting answer data to the processor; and
computer memory coupled to the processor and having recorded within it machine readable instructions for:
storing the answer data previously input to the processor;
providing the stored answer data to a reader device;
storing unique identifier data that corresponds to a user; and
providing the stored unique identifier data to a reader device;
wherein the instructions for providing the stored unique identifier data to a reader device may be utilized independently of the instructions for providing the stored answer data to a reader device.

2. The device of claim 1, further comprising a lanyard for placement adjacent a user's neck, the lanyard being operatively coupled to the processor, the means for inputting answer data, and the computer memory.

3. The device of claim 2, wherein the lanyard is a break-away lanyard.

4. The device of claim 1, wherein the means for inputting answer data to the processor includes a plurality of buttons.

5. The device of claim 1, wherein the means for inputting answer data to the processor includes a keypad having alphanumeric indicia.

6. The device of claim 1, further comprising a display in data communication with the processor, and wherein the computer memory has recorded within it machine readable instructions for actuating the display to present the stored answer data.

7. The device of claim 6, wherein the display is a liquid crystal display.

8. The device of claim 1, further comprising means for powering the processor.

9. The device of claim 8, wherein the means for powering the processor includes at least one of a battery or a solar cell.

10. A student assessment system, comprising:
a student device having at least one processor, a keypad in data communication with the student device processor for inputting answer data to the student device processor, means for powering the student device processor, computer memory in data communication with the student device processor, and a display in data communication with the student device processor, wherein the student device computer memory has recorded within it machine readable instructions for:
storing answer data input to the student device processor via the keypad; and
storing unique identifier data that corresponds to a user; and
a reader device having at least one processor, an input device in data communication with the reader device processor, means for powering the reader device processor, and computer memory in data communication with the reader device processor;
means for transferring the stored answer data to the reader device processor; and
means for transferring the stored unique identifier data to the reader device processor.

11. The student assessment system of claim 10, wherein the means for transferring the stored answer data to the reader device processor includes:
a magnetically coupled circuit in communication with the student device processor and the reader device processor;
machine readable instructions stored in the reader device memory for receiving the stored answer data via the magnetically coupled circuit; and
machine readable instructions stored in the student device memory for providing the stored answer data via the magnetically coupled circuit.

12. The student assessment system of claim 11, wherein the magnetically coupled circuit has a communication range of less than six inches.

13. The student assessment system of claim 11, wherein the means for transferring the stored unique identifier data to the reader device processor includes:
the magnetically coupled circuit;
machine readable instructions stored in the reader device memory for receiving the stored unique identifier data via the magnetically coupled circuit; and
machine readable instructions stored in the student device memory for providing the stored unique identifier data via the magnetically coupled circuit.

14. The student assessment system of claim 13, wherein the machine readable instructions stored in the reader device memory for receiving the stored unique identifier data and the machine readable instructions stored in the student device processor for providing the stored unique identifier data may be utilized independently of the machine readable instructions stored in the reader device memory for receiving the stored answer data and the machine readable instructions stored in the student device processor for providing the stored answer data.

15. The student assessment system of claim 11, wherein:
the reader device comprises a personal computer and a reader unit;
the reader unit is removably coupled to the personal computer;
the reader unit includes a first magnetic coil;
the student device includes a second magnetic coil in data communication with the student device processor; and
the magnetically coupled circuit includes the first and second magnetic coils.

16. The student assessment system of claim 10, wherein the student device includes a lanyard for placement adjacent a user's neck, the lanyard being operatively coupled to the student device processor, the keypad, student device computer memory, and the student device display.

17. A method of administering an examination, the method comprising the steps of:
A) providing each of a plurality of students with a respective student device, each student device having at least one processor, a keypad in data communication with the student device processor for inputting answer data to the student device processor, means for powering the student device processor, computer memory in data communication with the student device processor, and a display in data communication with the student device processor, wherein the student device computer memory has recorded within it machine readable instructions for:
storing answer data input to the student device processor via the keypad; and
storing unique identifier data that corresponds to a user; and
B) providing at least one examination question without use of the student devices;
C) having the students utilize the respective keypads to input answer data to the respective student device processors;
D) providing a reader device having at least one processor, an input device in data communication with the reader device processor, means for powering the reader device processor, and computer memory in data communication with the reader device processor;
E) transferring the answer data from the respective student device computer memories to the reader device processor.

18. The method of claim 17, further including the step of having the students utilize the respective student device displays to verify the input answer data.

19. The method of claim 17, wherein the step of transferring the answer data from the respective student device computer memories to the reader device processor utilizes the respective unique identifier data to associate the answer data with the students.

20. The method of claim 17, wherein:
the reader device computer memory has recorded within it machine readable instructions for associating the respective unique identifier data with identities of respective students; and
the method further includes the step of transferring the unique identifier data from a respective student device computer memory to the reader device processor to obtain the identity of the student in possession of the respective student device.

21. The method of claim 17, wherein steps B, C, and E are repeated for a subsequent examination.

22. The method of claim 17, wherein once each student is provided with a respective student device, each respective student maintains the respective student device in his possession for future use.

23. The method of claim 17, wherein:
step E is performed after steps A, B, C, and D;
each respective student device includes a lanyard;
the method further includes step:
F) instructing the students to place the respective student devices adjacent their necks using the respective lanyards; and
step F is performed after step E.
